(19) United States
(12) Patent Application Publication
(10) Pub. No.: US 2020/0180923 A1
(43) Pub. Date: Jun. 11, 2020

(54) Loader With Operator Elevator System

(71) Applicant: Logging Equipment Mfg. Co., Inc., Hill City, MN (US)

(72) Inventor: Bruce E. Christensen, Grand Rapids, MN (US)

(21) Appl. No.: 16/211,638

(22) Filed: Dec. 6, 2018

(51) Int. Cl. B66F 7/18; B60R 3/02; B66F 7/28; B66C 1/58; B66C 23/36

(52) U.S. Cl. CPC B66F 7/18; B60R 3/02; B66F 2700/057; B66C 1/58; B66C 23/36; B66F 7/28

(57) ABSTRACT

The invention provides a knuckle boom loader having a knuckle boom, an operator seat, and a hydraulic system. The hydraulic system comprises a hydraulic fluid reservoir, a hydraulic pump, and hydraulic fluid lines. The knuckle boom loader further comprises an operator elevator having an elevator platform. The operator elevator has both a lowered position and a raised position. The elevator platform is closer to the operator seat when the operator elevator is in the raised position than when the operator elevator is in the lowered position. Also provided are methods for operating such a loader.

### FIELD OF THE INVENTION

The present invention relates generally to a loader for moving logs, railroad ties, scrap, or other items. The present invention also provides methods for operating such a loader.

### BACKGROUND OF THE INVENTION

Various knuckle boom loaders are known. Knuckle boom loaders can be mounted on a truck or trailer, for example, to assist with moving items, such as logs, railroad ties, scrap or the like. Certain knuckle boom loaders include an elevated operator station having controls and an operator seat. To allow an operator to climb up to and down from the operator station, such knuckle boom loaders often include a ladder.

As set forth in the present disclosure, it would be desirable to provide a knuckle boom loader having an operator elevator for moving an operator between an operator station and a ground surface. In some cases, it would be desirable to provide an operator elevator that is powered by the same hydraulic system that powers the knuckle boom of the loader. It would also be desirable to provide an operator elevator of this nature that has advantageous structural, operational and/or safety features.

### SUMMARY OF THE INVENTION

In certain embodiments, the invention provides a knuckle boom loader having a knuckle boom, an operator seat, and a hydraulic system. The hydraulic system includes a hydraulic fluid reservoir, a hydraulic pump, and hydraulic fluid lines. The knuckle boom loader further includes an operator elevator having an elevator platform. The operator elevator has both a lowered position and a raised position. The elevator platform is closer to the operator seat when the operator elevator is in the raised position than when the operator elevator is in the lowered position.

In some of the present embodiments, with the knuckle boom loader operably positioned, the elevator platform is: (i) adjacent a ground surface when the operator elevator is in the lowered position, and (ii) adjacent the operator seat when the operator elevator is in the raised position. As shown in FIG. 1, the operator elevator 400 can optionally be configured such that when its elevator platform 430 is in the lowermost operational position, the elevator platform is elevated above the ground (i.e., is not flush or aligned with the ground surface). In such cases, it may be at least several inches above the ground, such as at least four inches, at least six inches, or at least 8 inches, while preferably being no more than 36 inches, 30 inches, or 24 inches above the ground. It is to be appreciated, however, that the present elevator can alternatively be configured such that the elevator platform is even closer to the ground when the elevator is in the lowered position.

In some cases, the hydraulic system includes a single hydraulic circuit configured to power both the knuckle boom and the operator elevator.

Preferably, the hydraulic fluid lines of the hydraulic system include a power line extending from the hydraulic pump to the knuckle boom (e.g., to a hydraulic valve located on the knuckle boom), the operator elevator includes a hydraulic manifold block, and the hydraulic manifold block of the operator elevator can optionally be positioned on the power line between the hydraulic pump and the knuckle boom. Additionally or alternatively, the noted power line can extend from the hydraulic pump to a valve located on the knuckle boom, or located elsewhere on the loader, and the valve can be configured to facilitate hydraulic fluid flow to the knuckle boom. In such cases, at least some of the hydraulic fluid from such power line preferably is used to power a cylinder of the elevator and at least some of the hydraulic fluid from such power line preferably is configured to power a cylinder that is located on and/or acts on the boom. In some cases, the power line includes an ingress length that delivers hydraulic fluid from the hydraulic pump into the hydraulic manifold block of the operator elevator, and the power line includes an egress length that delivers hydraulic fluid from the hydraulic manifold block of the operator elevator to the knuckle boom.

The present knuckle boom loader preferably includes two outrigger legs, with the operator elevator carried alongside a first of the two outrigger legs. Further, the knuckle boom loader can optionally include a ladder carried alongside a second of the two outrigger legs.

In the present embodiments, the operator elevator can optionally include a first chain and a first sprocket, with the elevator platform being operably connected to the first chain, and the first sprocket being intermeshed with the first chain. Further, the operator elevator preferably includes a hydraulic cylinder operably coupled to a bushing on which the first sprocket is rotatably mounted, such that in response to axial movement of the hydraulic cylinder the bushing moves vertically (or at least generally or substantially vertically), thereby causing the first sprocket to move along the first chain such that the elevator platform moves between raised and lowered positions. Still further, the operator elevator can optionally include a second chain and a second sprocket, with the elevator platform being operably connected to the second chain, and the second sprocket being intermeshed with the second chain. In such cases, the second sprocket preferably is rotatably mounted to the bushing, such that in response to axial movement of the hydraulic cylinder the bushing moves vertically (or at least generally or substantially vertically), thereby actuating the first and second sprockets to move respectively along the first and second chains such that the elevator platform moves between raised and lowered positions.

In the present embodiments, the elevator platform may have first and second actuator pedals. In such cases, with the knuckle boom loader operably positioned, the elevator platform preferably is configured to: (i) move upward (e.g., vertically upward) in response to an operator stepping on the first actuator pedal, and (ii) move downward (e.g., vertically downward) in response to the operator stepping on the second actuator pedal.

The operator elevator may also include wheels and tracks, with the wheels being received in the tracks. For example, the operator elevator may include a frame defining the tracks, and the wheels may be mounted to the elevator platform. Further, the operator elevator may have a facing wall located between two sidebars of the frame such that two vertical gaps are formed between the two sidebars of the frame and the facing wall. Still further, the elevator platform may have two brackets received respectively in the two vertical gaps (e.g., such that the two brackets are configured to move vertically along and within the two vertical gaps during operation of the elevator), with the two brackets carrying the wheels (e.g., such that the wheels ride along the tracks during operation of the elevator).

Preferably, the elevator platform has a deployed configuration and a stowed configuration, and the elevator platform is pivotable between the deployed configuration and the stowed configuration. Moreover, the operator elevator can optionally have a lock configured to releasably lock the elevator platform in the stowed configuration.

In the present embodiments, the operator elevator can advantageously include a handle. The handle can comprise two handle sections (e.g., two separate handle bars) located on opposite sides of the elevator. In such cases, the two handle sections are positioned for an operator to grasp respectively with first and second hands.

### BRIEF DESCRIPTION OF THE DRAWINGS

FIG. 1 is a side view of a knuckle boom loader in accordance with certain embodiments of the present disclosure, showing the knuckle boom loader operably positioned on a truck.

FIG. 2 is an opposite side view of the knuckle boom loader of FIG. 1, showing the knuckle boom loader operably positioned on the truck.

FIG. 3 is a rear view of a knuckle boom loader in accordance with certain embodiments of the present disclosure, showing an operator elevator in a lowered position, with the knuckle boom and the grapple removed for clarity.

FIG. 4 is a rear view of the knuckle boom loader of FIG. 3, showing the operator elevator in its lowered position with an operator standing on an elevator platform of the operator elevator.

FIG. 5 is a rear view of a knuckle boom loader in accordance with certain embodiments of the present disclosure, showing the operator elevator in a raised position, with the knuckle boom and the grapple removed for clarity.

FIG. 6 is a rear view of the knuckle boom loader of FIG. 5, showing the operator elevator in its raised position with an operator standing with one foot on the elevator platform and one foot on an elevated deck of the loader.

FIG. 7 is a partially broken-away front view of an operator elevator in accordance with certain embodiments of the present disclosure, showing the elevator platform in a deployed position.

FIG. 8 is a partially-broken away front perspective view of an operator elevator in accordance with certain embodiments of the present disclosure, showing the elevator platform in a stowed configuration.

FIG. 9 is a side view of an operator elevator in accordance with certain embodiments of the present disclosure, showing the operator elevator in its lowered position.

FIG. 10 is a rear view of the operator elevator of FIG. 9, showing the operator elevator in its lowered position.

FIG. 11 is another side view of the operator elevator of FIG. 9, showing the operator elevator in its raised position.

FIG. 12 is another rear view of the operator elevator of FIG. 9, showing the operator elevator in its raised position.

FIG. 13 is a schematic broken-away view of a hydraulic manifold block in accordance with certain embodiments of the present disclosure.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

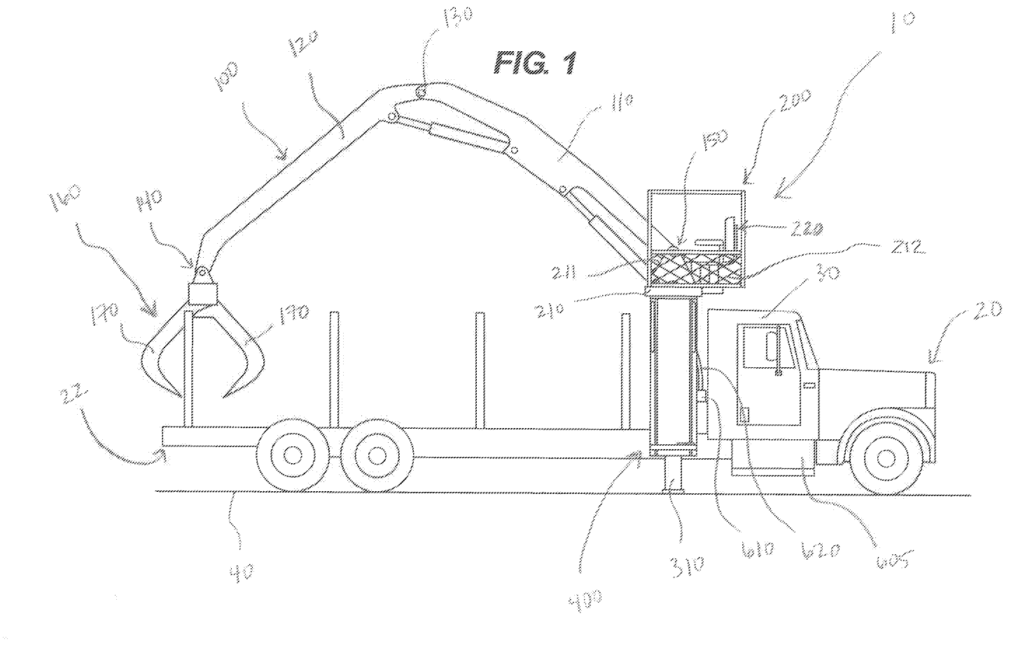

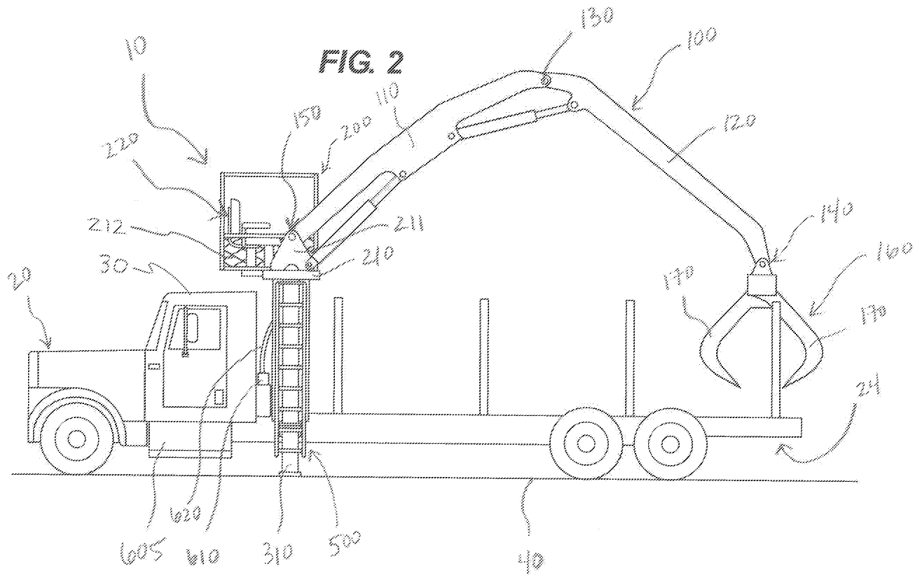

Referring to the drawings, and in particular, FIG. 1, there is shown a knuckle boom loader of the present disclosure generally represented by reference numeral 10. The knuckle boom loader 10 is configured to move items, such as logs, railroad ties, scrap or other materials. As shown in FIGS. 1 and 2, the knuckle boom loader 10 can be mounted to a truck 20, such as behind (e.g., and adjacent) a cab 30 of the truck 20. Alternatively, the knuckle boom loader can be mounted on a trailer. More generally, the knuckle boom loader can be mounted to various different platforms, bases, or carriages (e.g., a carriage configured to ride on the rails of a railroad track). As used in the present disclosure, the knuckle boom loader 10 is considered “operably positioned” when the knuckle boom loader 10 is set up for use (e.g., mounted to a truck or trailer or otherwise operably assembled).

The knuckle boom loader 10 has a knuckle boom 100 defined by a pair of jointed arms (or “boom sections”) 110, 120. The arms 110, 120 are connected to each other at a pivot point 130 that allows the knuckle boom 100 to pivot at the pivot point 130. As shown in FIGS. 1 and 2, the pivot point 130 can optionally be approximately equidistant between a first end 140 and a second end 150 of the knuckle boom 100. However, skilled artisans will appreciate that the pivot point 130 can be located closer to the first end 140 or to the second end 150 of the knuckle boom 100 than is shown in the figures. Various different types of booms can be used for the present loader; the particular boom type is not limiting to the invention.

The knuckle boom 100 preferably is hydraulically actuated. Thus, it preferably is equipped with at least one hydraulic cylinder. In the embodiment illustrated, the knuckle boom 100 has a plurality of hydraulic cylinders. For example, the boom 100 may have a main boom cylinder and a stick boom cylinder. In some cases, it may also have a grapple cylinder. A variety of conventional knuckle boom cylinders are commercially available from different suppliers, such as Lemco Hydraulics of Hill City, Minn., USA. Thus, the loader 10 preferably has one or more (e.g., a plurality of) hydraulic lines on the boom 100.

The knuckle boom 100 is shown with a grapple 160 attached to a first end 140 of the knuckle boom 100. The illustrated grapple 160 is a claw-like member configured to pick up items to be moved. As is well known to those skilled in this area of technology, the boom can be equipped with any of a wide variety of different grapples or attachments. The knuckle boom 100 can move the grapple 160 up and down (e.g., relative to a ground surface 40), forward and rearward (e.g., further from or closer to the cab 30 of the truck 20), and side-to-side. The grapple 160 can comprise any type of grapple or attachments known in the art and will be selected based on the intended use of the knuckle boom loader 10.

The illustrated grapple 160 includes a pair of tines 170 that are pivotally attached together. The tines 170 are configured to pivot toward each other to grasp an item to be moved and are configured to pivot away from each other to release the item after the knuckle boom loader 10 has moved the item to its desired location. In some cases, the grapple 160 has a single pair of tines as shown in FIGS. 1 and 2. In other embodiments, the grapple 160 has three or more tines. The tines 170 can be wider or narrower as needed to suit a particular application. More generally, the grapple can be any desired type of grapple or attachment. It need not have tines, much less the type of tines shown. The illustrated grapple can be replaced, for example, with various types of log grapples, combination grapples, clam shell grapples, compaction grapples, orange peel grapples, bucket attachments, glass pane attachments, rake attachments, railroad tie grapples, scrap handling attachments, pulpwood handling attachments, magnet rotators, butt tine grapples, tamping grapples, bale clamp grapples, or various rope or cable attachments.

The knuckle boom loader 10 includes an operator station 200. The operator station 200 preferably is adjacent to (e.g., and mounted to) a pedestal 210 to which the knuckle boom 100 is mounted. As shown in FIGS. 1 and 2, the pedestal 210 can optionally be positioned behind (at least in part), and elevated above, the cab 30 of the truck 20. The pedestal 210 rotates when the knuckle boom 100 swings in either direction (i.e., clockwise or counterclockwise). The illustrated pedestal 210 is configured to rotate together (i.e., conjointly) with the knuckle boom 100.

The knuckle boom 10 will commonly be mounted to the pedestal 210 via two mount brackets (e.g., plates) 211, which project vertically from the pedestal in the illustrated embodiment. In such cases, the knuckle boom 10 preferably is attached pivotally to the two mount brackets 211. In the embodiment of FIGS. 1 and 2, at least one hydraulic cylinder is attached between the boom 10 and the mount brackets 211, e.g., such that the boom pivots (e.g., in a vertical plane) relative to the mounting plates in response to actuation of such one or more cylinders.

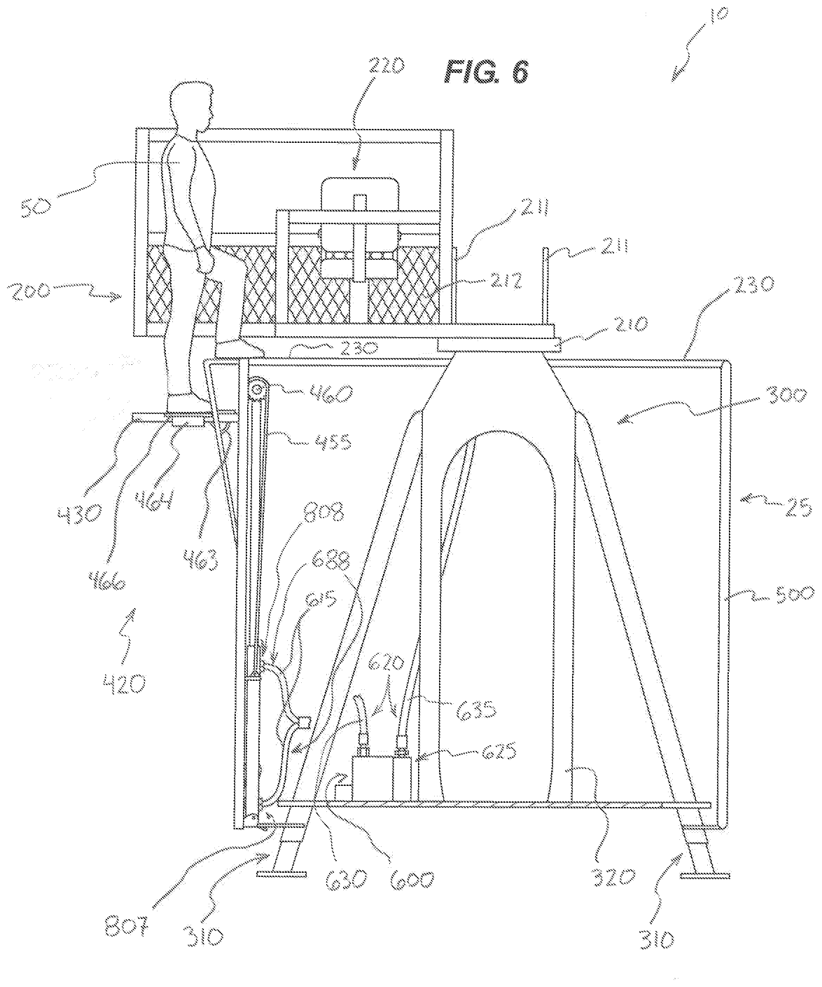

As shown in FIGS. 1-6, the operator station 200 includes an operator seat 220. An operator 50 can sit on the operator seat 220 while controlling the knuckle boom loader 10. The illustrated operator seat 220 is mounted on, or relative to, the pedestal 210 such that the seat is configured to rotate together with the pedestal 210. For example, the operator seat 220 can be mounted on a platform and/or framework that is mounted to the pedestal.

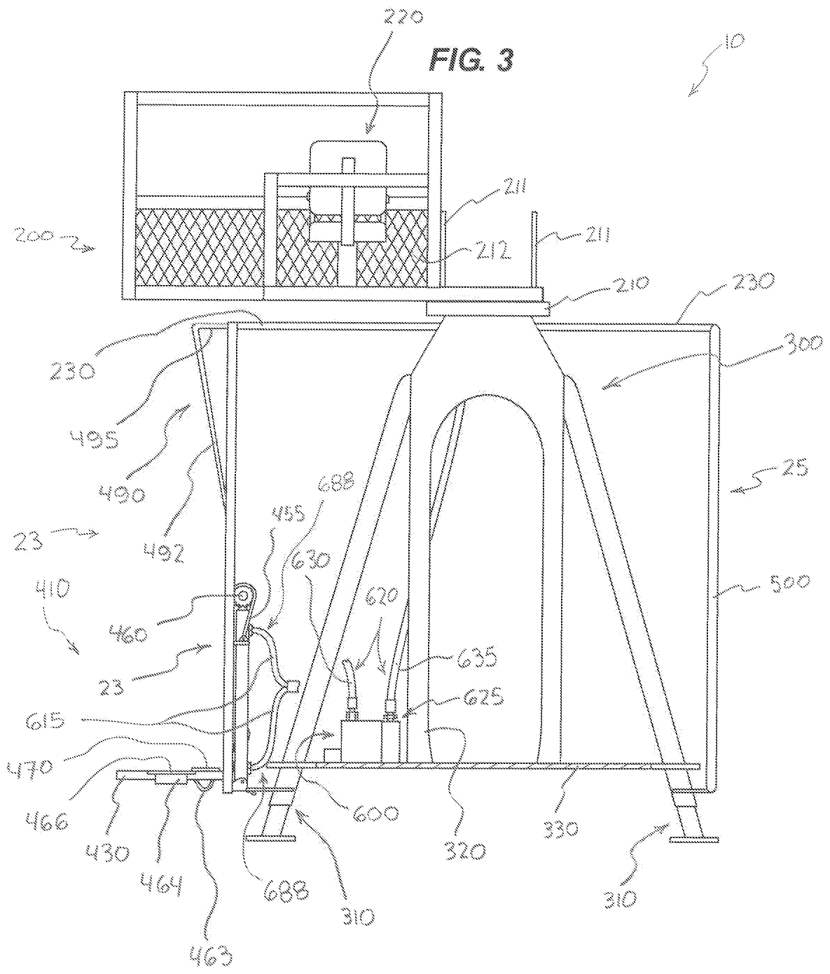

In the embodiment illustrated, the operator station 200 includes a cage 212 at least partially surrounding the operator seat 220. Here, the operator station 200 comprises a framework and platform that support the cage and are rigidly attached to the pedestal 210. This is perhaps best shown in FIGS. 3-6. Thus, the framework of the illustrated operator station 200 and the pedestal 210 are rigidly coupled together so as to rotate together as a single unit.

While the illustrated operator station 200 includes a cage 212, this is not required. For example, the operator seat may be attached directly to the pedestal (in which case there may optionally be no surrounding cage) or to a platform and/or framework that is attached to the pedestal. When provided, the platform (which may define a floor of the operator station) of the operator station preferably is coupled rigidly (directly or indirectly, e.g., via a framework) to the pedestal such that the platform and the pedestal are configured to rotate together as a single unit.

The loader 10 can optionally include a deck 230. The illustrated deck 230 is positioned adjacent the pedestal 210. As described in greater detail below, the operator 50 can step on the deck 230, when provided, in the process of getting into the operator seat 220, and can step on the deck 230 after getting out of the operator seat 220. In the illustrated embodiment, the deck 230 is an elevated deck, which is located adjacent the operator seat 220. The deck 230 is shown having two deck sections, one adjacent each side of the loader. In the embodiment illustrated, both sections of the deck are at the same elevation or at least substantially the same elevation (e.g., they can be substantially level with each other). More will be said of the deck later.

The knuckle boom loader 10 further includes a control system. The control system can include any conventional loader controls (mechanical control, hydraulic pilot control, or electro-hydraulic control) that allow the operator 50 to control operation of the knuckle boom loader 10. Such controls can include hand and/or foot-operated controls, such as joysticks and pedals (e.g., PCL4 joystick and foot pedal, which are available commercially from Parker Hannifin Corp., of Elyria, Ohio, U.S.A.). More generally, various well-known hydraulic components useful for the present invention and mentioned herein can be purchased from Parker Hannifin Corp. As is well known to skilled artisans, the control system can be provided adjacent the operator seat 220 such that the operator 50 can operate the control system while seated in the operator seat 220.

As shown in FIGS. 3-6, the pedestal 210 is supported by a frame or other base 300. In preferred embodiments, the frame or base 300 includes two outrigger (or “stabilizer”) legs 310. The outrigger legs 310 can be attached to opposite sides of a central support member (which can comprise a support column) 320. In this manner, the frame or base 300 can comprise an A-frame design, which can be used to provide the knuckle boom loader 10 with increased stability. While an A-frame type stabilizer is shown, other conventional types of stabilizers can be provided instead of, or in addition to, the illustrated A-frame type stabilizer. Furthermore, in some cases, the frame or base may be devoid of outrigger legs. The operator elevator 400 can optionally have a height that is substantially equal to (e.g., no more than 24 inches different from, no more than 18 inches different from, or no more than 12 inches different from) the height of central support member (which can comprise a support column) 320.

In some embodiments, the central support member 320 (e.g., a support column thereof) is mounted on a platform 330. In preferred embodiments of this nature, the platform 330 is positioned on, and secured to, a truck 20 or trailer. In other embodiments, there is no such platform and the central support member (e.g., a support column thereof) is positioned directly on (e.g., so as to contact) the truck or trailer. In such embodiments, the central support member can be secured directly to the truck or trailer.

When provided, the central support member 320 can optionally comprise (e.g., be) an upright column. In the embodiment illustrated, this column has a generally hollow construction with a vertically elongated opening extending along a major (i.e., more than 50%) height of the column. These details, however, are by no means required.

The outrigger legs 310 are positionable to engage a ground surface 40 (see FIGS. 1 and 2). When the outrigger legs 310 engage the ground surface 40, they stabilize the knuckle boom loader 10 by providing leverage to the knuckle boom loader 10. In preferred embodiments, the outrigger legs 310 are telescopic such that they can be extended downwardly to engage the ground surface 40, and telescopically retracted to enable transport of the truck or trailer. In addition, the outrigger legs 310 preferably are individually adjustable such that each outrigger leg 310 can extend different lengths relative to the other outrigger leg 310 in order to facilitate stably positioning the outrigger legs 310 on uneven terrain.

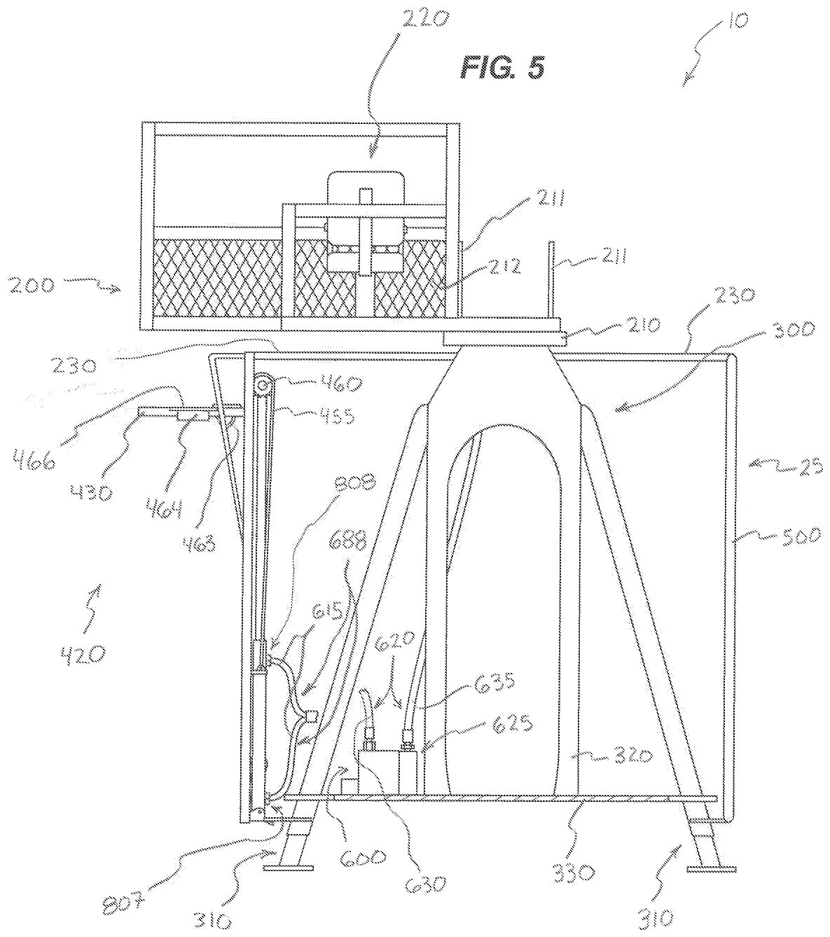

The present knuckle boom loader 10 has an operator elevator 400. The operator elevator 400 has both a lowered position 410 (FIGS. 1, 3, 4, 9, and 10) and a raised position 420 (FIGS. 5, 6, 11, and 12). The operator elevator 400 includes a movable elevator platform 430. The elevator platform 430 is at a higher elevation, and thus closer to the operator seat 220, when the operator elevator 400 is in the raised position 420 than when the operator elevator 400 is in the lowered position 410. Thus, the elevator platform 430 is moveable upwardly and downwardly. When the knuckle boom loader 10 is operably positioned, the elevator platform 430 is: (i) adjacent the ground surface 40 when the operator elevator 400 is in the lowered position 410, and (ii) adjacent the operator seat 220 when the operator elevator 400 is in the raised position 420. Preferably, the elevator is configured such that an operator 50 can stand on the elevator platform 430 and actuate it to move downwardly from adjacent the operator station 200 to adjacent the ground surface 50, or upwardly from adjacent the ground surface 50 to adjacent the operator station 200. For example, the elevator preferably is configured such that: (i) when the elevator platform 430 is in a lowered position, an operator 50 standing on the elevator platform can operate it so as to move the elevator upwardly, (ii) when the elevator platform 430 is in a raised position, an operator 50 standing on the elevator platform can operate it so as to move the elevator downwardly, and (iii) when the elevator platform 430 is between raised and lowered positions, an operator 50 standing on the elevator platform can operate it so as to move the elevator either upwardly or downwardly. The elevator can optionally be configured to move upwardly and downwardly at the same, or substantially the same, rate.

The illustrated operator elevator 400 is mounted alongside (e.g., so as to extend vertically alongside) a first of the two outrigger legs 310. It is to be appreciated, however, that this is not required. For example, the loader may have outrigger legs at different locations.

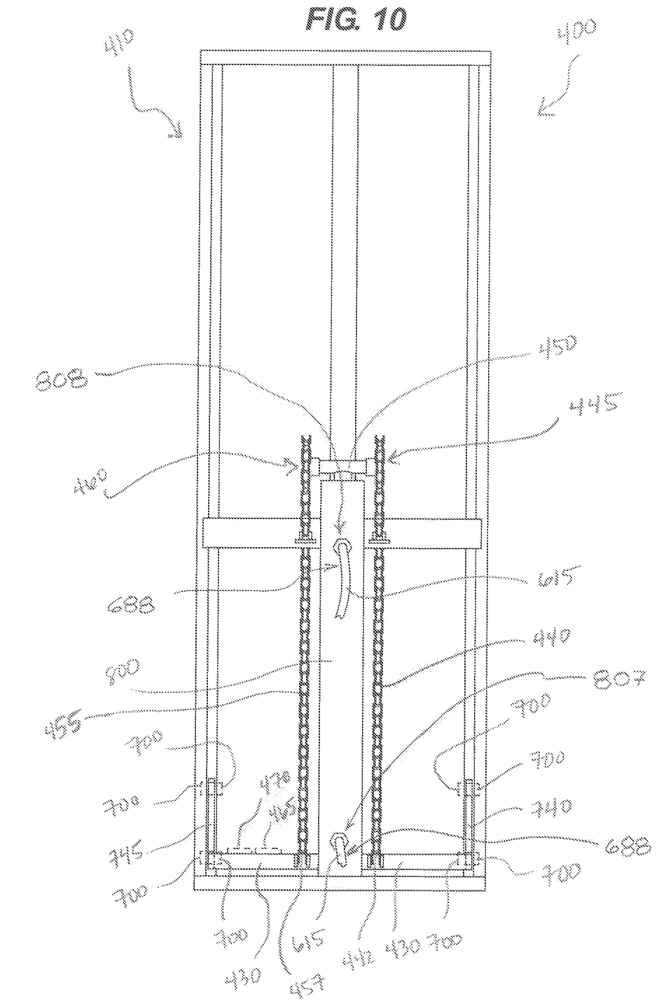

The operator elevator 400 preferably is hydraulically actuated. It preferably includes a hydraulic cylinder 800. The illustrated hydraulic cylinder 800 is mounted in an upright configuration (such that its cylinder axis is upright, e.g., vertical). In such cases, the operator elevator 400 is configured to move between its raised and lowered positions in response to axial movement of the cylinder 800. Reference is made to FIGS. 10-12.

The operator elevator 400 can optionally have a fail-safe system configured to lower the elevator platform 430 slowly and/or at a controlled rate if a hydraulic line connected to hydraulic cylinder 800 fails. The fail-safe system preferably comprises a flow control valve 645. The fail-safe system can include, for example, a needle valve or other flow control valve operably connected to hydraulic cylinder 800 and/or to a hydraulic line extending to (e.g., configured to deliver hydraulic fluid to) the hydraulic cylinder 800.

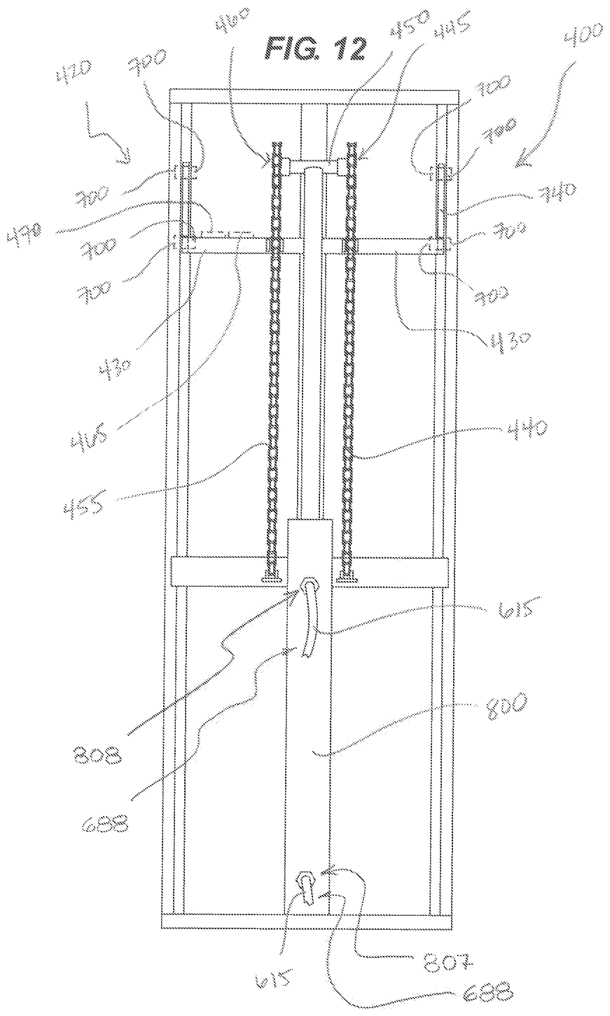

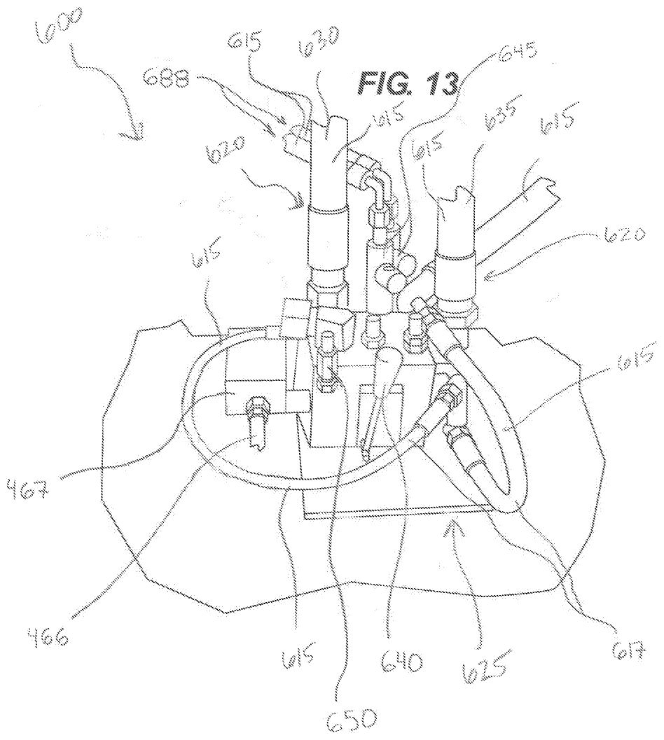

If desired, such a flow control valve 645 can be connected to a hydraulic line 615, 688 extending to a bottom chamber of hydraulic cylinder 800. In such cases, the flow control valve 645 can be connected to a hydraulic line 615, 688 attached to an A port 807 (which in the illustrated embodiment communicates with a hydraulic chamber at a bottom of the cylinder) of hydraulic cylinder 800. Reference is made to FIGS. 12 and 13. In other cases, the flow control valve can be connected directly to the A port of hydraulic cylinder 800, e.g., such that there is no separate length of hydraulic line between hydraulic cylinder 800 and such flow control valve.

When provided, the noted needle valve or other flow control valve 645 preferably is constructed such that if a respective hydraulic line connected to hydraulic cylinder 800 fails (e.g., if a hydraulic line in communication with a hydraulic chamber at a bottom of the cylinder fails), such that due to the failure hydraulic fluid backflows out of a bottom hydraulic chamber of the cylinder, the flow control valve maintains such backflow of hydraulic fluid from hydraulic cylinder 800 only at a reduced flow rate compared to a full forward flow rate of the flow control valve. In such cases, the fail-safe system preferably is configured such that, in the event of such a hydraulic line failure, the elevator platform 430 moves downwardly with controlled acceleration and/or does not exceed a certain maximum downward velocity due to the action of the needle valve or other flow control valve 645. As just one example, such needle valve or other flow control valve 645 may ensure a downward acceleration that is slower than the acceleration of gravity for a free-falling object, i.e., less than about 9.8 m/s². The needle valve or other flow control valve may be configured to ensure a downward acceleration that is more than 20% less (or more than 30% less, or more than 50% less, or even more than 75% less) than the acceleration of gravity for a free-falling object. When provided, the needle valve or other flow control valve may be constructed to allow full forward flow and reduced backflow. Preferably, an adjustable flow control needle valve is used. In such cases, the valve can be set so that backflow is reduced compared to a full forward flow rate, such as reduced by at least 10%, at least 20%, or at least 30%. This can optionally also be the case when the valve is non-adjustable. Various commercially available flow control valves can be used. Two suitable examples are the F400 and F600 adjustable needle valves, which are commercially available from Parker Hannifin Corp.

In embodiments wherein a bottom chamber of hydraulic cylinder 800 is provided with a flow control valve 645, a top chamber of hydraulic cylinder 800 can optionally also be provided with a flow control valve 645. Reference is made to the two flow control valves 645 shown in FIG. 13. In such cases, both flow control valves 645 may be of the same type. Embodiments of this nature can advantageously be configured to ensure that, in the event of hydraulic line failure of the type noted above, the elevator platform 430 accelerates downwardly at the same rate at which the elevator platform accelerates upwardly during a normal lifting operation of the elevator. It is to be appreciated, however, that the bottom chamber of hydraulic cylinder 800 may be provided with a flow control valve 645 while the top chamber of hydraulic cylinder 800 is not. Furthermore, it is not required that the bottom chamber of hydraulic cylinder 800 have any flow control valve.

As noted above, the illustrated embodiment of the loader 10 includes an elevated deck 230. The deck 230 preferably has a section located adjacent the operator elevator 400. That section of the deck 230 preferably extends from the elevator generally toward the pedestal 210. The operator can thus ride the elevator up the loader and, upon reaching the top of the elevator, step off the elevator and onto the deck 230. The operator can then step from the deck 230 into the operator station 200. Thus, the deck 230 preferably is at substantially the same elevation as the top of the elevator 400.

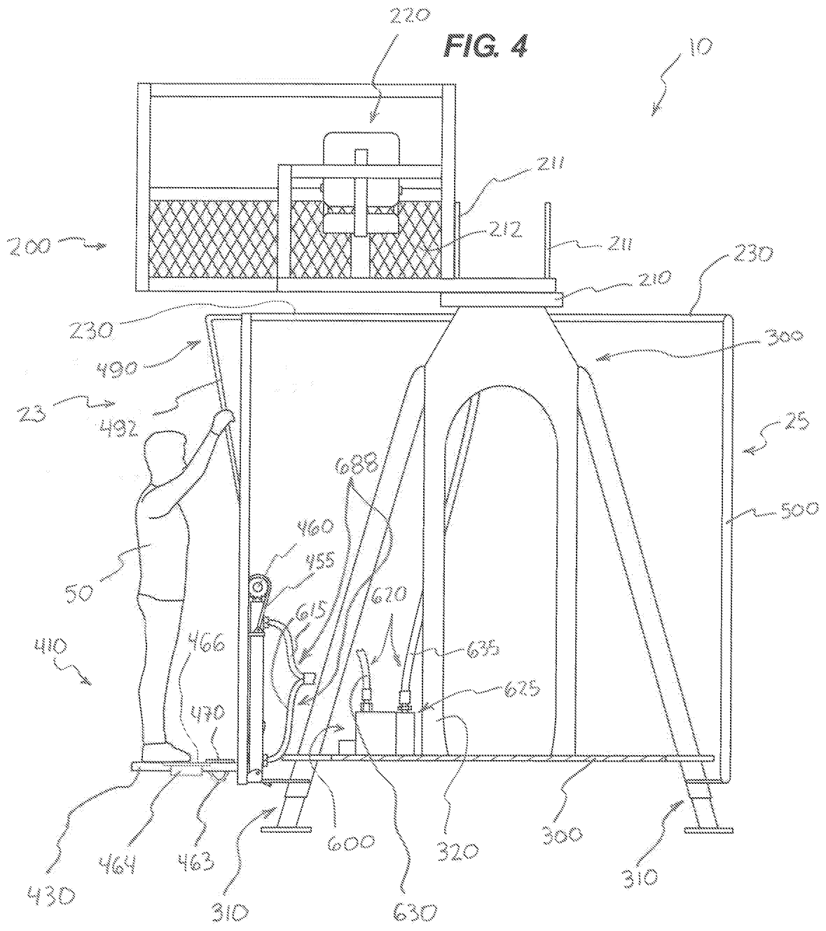

In some embodiments, the operator elevator 400 includes a handle 490. The operator 50 can hold onto the handle 490, when provided, while riding the operator elevator 400 (see FIG. 4) and/or while stepping onto the elevator platform 430. When provided, the handle can comprise two handles or two handle sections (e.g., two separate handle bars) located on opposite sides of the elevator. In such cases, the two handles or handle sections preferably are positioned for an operator to grasp respectively with first and second hands. As shown in FIGS. 3-6, the optional handles 490 can comprise brackets mounted to a frame or wall of the operator elevator 400. However, skilled artisans will appreciate that various other structures that can be safely grasped by the operator 50 may alternatively be used.

Preferably, the knuckle boom loader also includes a ladder 500. In some cases, the ladder 500 is mounted alongside a second of two outrigger legs 310 on the loader. In embodiments of this nature, the operator elevator 400 is located on a first side 23 of the knuckle boom loader 10, whereas the ladder 500 is located on a second side 25 of the knuckle boom loader 10. An arrangement of this nature allows the operator 50 to choose between riding the operator elevator 400 and climbing up and down the ladder 500 in order to move between the operator station 200 and the ground surface 40. Thus, the operator elevator 400 and a ladder 500 can be mounted on opposite sides of the loader 10. In such cases, the deck 230 can advantageously include two sections, including one section adjacent the elevator 400 (e.g., extending horizontally away from a top of the elevator) and another section adjacent the ladder 500 (e.g., extending horizontally away from a top of the ladder). When provided, the deck section adjacent the ladder preferably extends from the ladder generally toward the pedestal 210. Similarly, when provided, the deck section adjacent the elevator preferably extends from the elevator generally toward the pedestal 210. In the illustrated embodiment, the deck 230 is at substantially the same elevation as both the top of the ladder and the top of the elevator.

It is to be appreciated that the operator elevator 400 and the ladder 500 can be provided in other locations on the loader. For example, the operator elevator and the ladder can be positioned side-by-side, rather than being on opposite sides of the loader. Another possibility is to have the ladder on a front or rear of the loader while the operator elevator is on a side of the loader. In other cases, the loader may have only the operator elevator, but no ladder.

The knuckle boom loader has a hydraulic system 600. The hydraulic system 600 comprises a hydraulic fluid reservoir 605 (see FIGS. 1 and 2), a hydraulic pump 610, and hydraulic fluid lines 615. The hydraulic fluid reservoir 605 is a container that holds hydraulic fluid. As one non-limiting example, the reservoir 605 can be a conventional 30 gallon reservoir with a sight gauge, screen, shut off and stainless steel coil for cold weather heating. Various conventional reservoir types can be used. The hydraulic pump 610 is configured to move hydraulic fluid from the hydraulic fluid reservoir 605 through one or more of the hydraulic fluid lines 615, and preferably to the knuckle boom 100 such that the hydraulic system 600 is configured to power the knuckle boom 100. In certain embodiments, the pump 610 is a conventional load sense piston pump. The hydraulic reservoir 605 and the hydraulic pump 610 are not limited in terms of where they are positioned.

Preferably, the hydraulic system 600 is configured to only power components of a knuckle boom loader 10. For example, the hydraulic system 600 can optionally be configured to only power (i.e., deliver hydraulic fluid for operating) one or more cylinders of (e.g., on) a knuckle boom and one or more cylinders of an operator elevator.

Preferably, the hydraulic system includes a single hydraulic circuit configured to power (and/or includes a single power line pathway configured to deliver hydraulic fluid to) both the operator elevator and another location on the loader, such the knuckle boom. In some cases, the hydraulic system 600 is a single hydraulic system configured to power both the knuckle boom 100 and the operator elevator 400. For example, a hydraulic cylinder 800 of the elevator 400 preferably is on the same hydraulic circuit and/or is configured to receive hydraulic fluid from the same power line pathway as at least one hydraulic valve and/or cylinder located elsewhere on the loader, such as on the central support member 320, or on the pedestal 210 and/or between brackets 211 and/or on the boom 100. For example, such power line pathway can be configured to deliver hydraulic fluid to both a cylinder 800 of the operator elevator and a valve and/or cylinder on the boom. This can optionally be the case in any embodiment of the present disclosure. However, it is envisioned that in alternate embodiments, one hydraulic system can be configured to power the knuckle boom 100, while a separate hydraulic system is configured to power only the operator elevator 400.

Thus, in some cases, the hydraulic fluid lines 615 include a power line 620 extending from the hydraulic pump 610 to the knuckle boom 100 (e.g., to a valve configured to service the boom). In such cases, the operator elevator 400 preferably has a hydraulic manifold block 625 positioned on the power line 620 between the hydraulic pump 610 and the knuckle boom 100. As shown best in FIGS. 3, 4, and 13, the power line 620 comprises an ingress length 630 and an egress length 635. The ingress length 630 delivers hydraulic fluid from the hydraulic pump 610 into the hydraulic manifold block 625 of the operator elevator 400, whereas the egress length 635 delivers hydraulic fluid from the hydraulic manifold block 625 of the operator elevator 400 to the knuckle boom 100 (e.g., to a hydraulic valve and/or cylinder elsewhere on the loader, such as on the boom). In some embodiments, the hydraulic manifold block 625 is mounted on the platform 330 of the frame 300 (FIGS. 3-6). In the embodiment illustrated, the hydraulic manifold block 625 is located between the central support member 320 and one of the outrigger legs 310. This is representative of embodiments wherein the hydraulic manifold block 625 is adjacent the elevator platform 430 when the elevator is in its lowered position. It is to be appreciated, however, that the hydraulic manifold block can be provided at various other locations on the loader. In the embodiment illustrated, the hydraulic manifold block 625 is mounted on the loader 10 so as to remain in a fixed elevation (e.g., in a fixed position) while the elevator platform 430 moves upwardly or downwardly.

As shown in FIGS. 10 and 12, the operator elevator 400 preferably comprises a first chain 440 and a first sprocket 445. When provided, the first sprocket 445 is intermeshed with the first chain 440. In such cases, the elevator platform 430 is connected to the first chain 440. In some embodiments, a bottom end 442 of the first chain 440 is attached to the elevator platform 430 (FIGS. 10 and 12). Preferably, the operator elevator 400 comprises a hydraulic cylinder 800 operably coupled to a bushing 450 on which the first sprocket 445 is rotatably mounted. A bearing can be provided on an axle of the bushing 450 to allow the first sprocket 445 to rotate relative to the bushing 450 in a conventional manner. In response to axial movement of the hydraulic cylinder 800, the bushing 450 moves vertically. This in turn causes the first sprocket 445 to move along the first chain 440 such that the elevator platform 430 moves either upward or downward as the operator elevator 400 moves between its raised 420 and lowered 410 positions. Thus, the operator elevator 400 preferably is configured to move between lowered and raised positions in response to axial movement of the hydraulic cylinder 800.

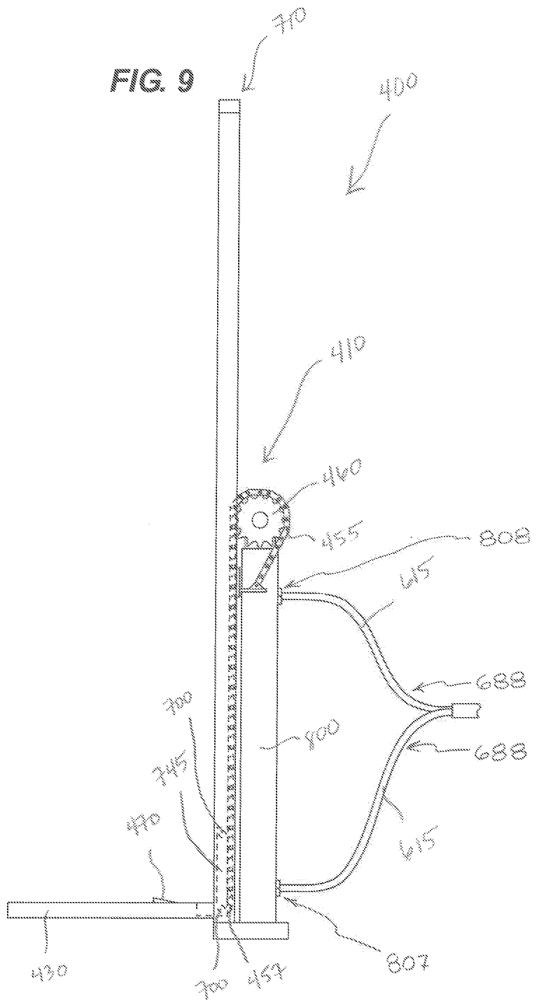

In certain preferred embodiments, the operator elevator 400 comprises a second chain 455 and a second sprocket 460. When provided, the second sprocket 460 is intermeshed with the second chain 455. In such cases, the elevator platform 430 is connected to the second chain 455. In certain embodiments, a bottom end 457 of the second chain 455 is attached to the elevator platform 430 (FIGS. 9-12). Similar to the first sprocket 445, the second sprocket 460 is rotatably mounted to the bushing 450, such that in response to axial movement of the hydraulic cylinder the bushing 450 moves vertically. This in turn actuates the first 445 and second 460 sprockets to move respectively along the first 440 and second 455 chains such that the elevator platform 430 moves either upward or downward as the operator elevator 400 moves between the raised 420 and lowered 410 positions.

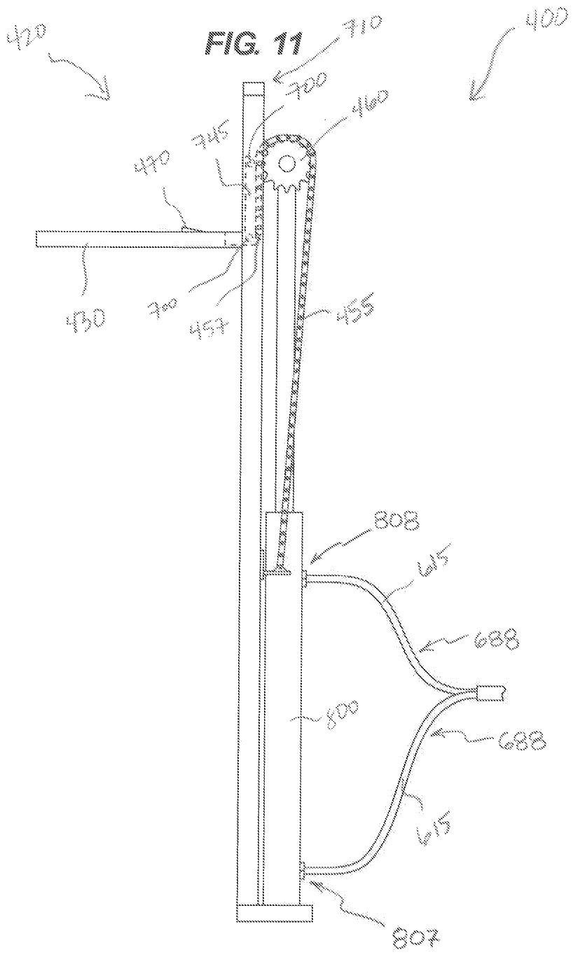

In embodiments where a second chain 455 is included, it provides the operator elevator 400 with an additional safety feature. If one of the chains 440, 455 were to break while the operator elevator 400 is in the raised position 420 (or is in the process of moving between the raised 420 and lowered 410 positions), the other chain would prevent the operator elevator (and any operator thereon) from falling to the lowered position. Thus, each chain 440, 455 preferably is configured to support the full weight of an operator on the platform. It is to be appreciated, however, that the operator elevator can alternatively have only a single chain of this nature. As can be appreciated by comparing FIGS. 9 and 10 with FIGS. 11 and 12, the bushing 450, first chain 440, and second chain 455 collectively move up or down as the elevator platform 430 moves up or down. Thus, the elevator platform 430 preferably is configured to move vertically along the loader 10 in response to vertical movement of one or more chains 440, 455 of the elevator 400. Alternatively, the elevator platform could be attached directly to cylinder 80 or a projection thereof or a subassembly connection, such that the elevator platform moves upwardly or downwardly following axial movement of cylinder 80. Other arrangements using cable or the like instead of the chains may also be provided.

In other embodiments, the hydraulic cylinder of the elevator is adapted to bear directly against a flange or other member rigidly connected to the elevator platform. For example, a cross beam on the back of the elevator can be rigidly connected to two upward projections of the elevator platform. A top end of the cylinder can be positioned to bear directly against the cross beam. In embodiments of that nature, the chains 440, 455 can be omitted. In another alternative, a single upward projection (e.g., a vertical bar or wall) from the elevator platform may have a flange extending in a rearward direction so as to be engaged by a top end of the cylinder. Other suitable configurations will be apparent to skilled artisans given the present teaching as a guide.

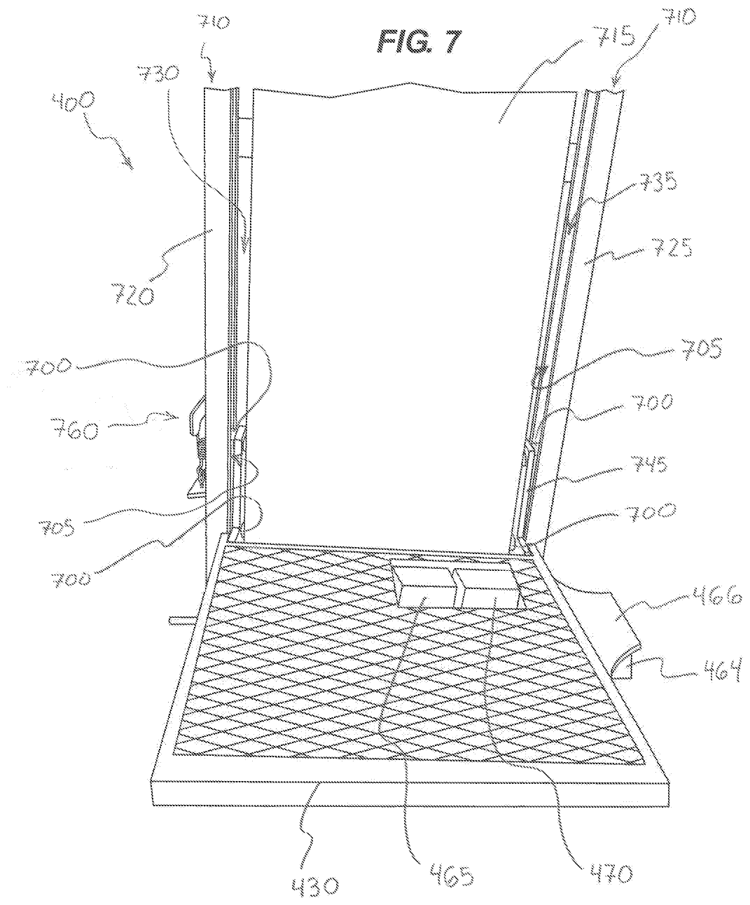

To allow the operator 50 to control movement of the elevator platform 430 (e.g., between raised and lowered positions), the elevator platform 430 preferably is provided with first 465 and second 470 actuator pedals. Reference is made to FIG. 7. In more detail, when the knuckle boom loader is operably positioned, the elevator platform 430 is configured to: (i) move upward in response to an operator 50 stepping on the first actuator pedal 465, and (ii) move downward in response to the operator 50 stepping on the second actuator pedal 470. Thus, the operator 50 can simply step on the first 465 or second 470 actuator pedals to respectively move the elevator platform 430 up or down, as desired. It is to be appreciated that the first operator pedal 465 can alternatively be configured to move the elevator platform 430 downward while the second operator platform 470 is configured to move the elevator platform upward.

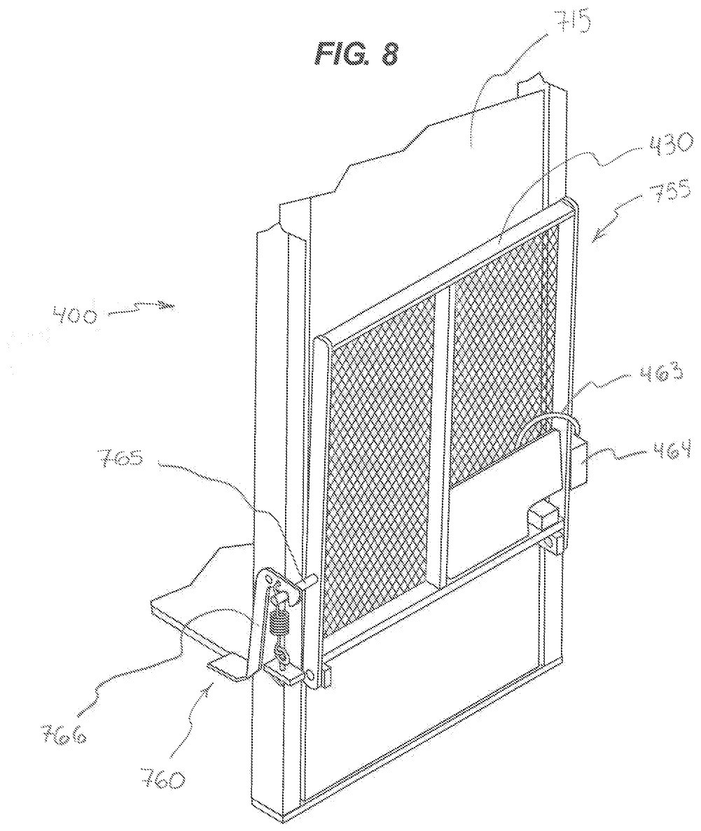

FIGS. 7 and 8 show a non-limiting example of a suitable electric pedal system. Here, the electric pedal system includes an electrical box 464, which preferably is a water-proof electrical box, and one or more wires 463. Suitable foot controls are commercially available from a variety of suppliers. One suitable example is the TWIN 971-SMC48, which is commercially available from LINEMASTER Switch Corporation of Woodstock, Conn., USA.

In the embodiment illustrated, the electrical box 464 is located under an optional shield plate 466. When provided, the shield plate 466 can optionally be fixed (e.g., welded) to the elevator platform so as to project from a lateral side thereof.

In the embodiment illustrated, both pedals 465, 470 are on the elevator platform 430. In other cases though, elevator actuators can be located elsewhere on the loader. As one example, a hand-held remote control can be provided. As another example, up and down actuator buttons can be provided on a frame or panel of the elevator.

The illustrated operator elevator 400 also comprises wheels 700 and tracks 705. As shown in FIGS. 7, 10, and 12, the wheels 700 are configured to ride along the tracks 705. Thus, the wheels 700 preferably are received in the tracks 705. The illustrated elevator 400 has a frame 710 defining the tracks 705. Here, the tracks 705 comprise channels (e.g., vertically extending channels) defined by the frame 710.

The illustrated elevator platform 430 is pivotally connected to two brackets (or “arms”) 740, 745 that carry the wheels 700. Preferably, each of the two brackets 740, 745 carries at least two wheels 700. In such cases, the wheels 70 on each bracket 740, 745 preferably are spaced apart along a height of the bracket. The two brackets 740, 745 and the wheels 700 form a shuttle, which is configured to move up and down along the tracks 705. When provided, the optional shuttle is configured to move the elevator platform 430 along the tracks 705. The shuttle can be provided in various other forms. Preferably, the shuttle is configured to move vertically along a frame 710 of the elevator 400, and the elevator platform 430 is attached pivotally to the shuttle.

The illustrated elevator platform 430 has (e.g., is movable between) a deployed configuration 750 (FIG. 7) and a stowed configuration 755 (FIG. 8). In some embodiments, the elevator platform 430 is pivotable between the deployed configuration 750 and the stowed configuration 755. Thus, the elevator platform 430 can be pivotably attached to the frame 710, optionally via the two brackets (or “arms”) 740, 745 or another shuttle assembly. The elevator platform 430 is positioned substantially perpendicular to the facing wall 715 of the operator elevator 400 when the elevator platform 430 is in the deployed configuration 750 and is positioned substantially parallel to the facing wall 715 of the operator elevator 400 when the elevator platform 430 is in the stowed configuration 755. This can be appreciated by comparing FIGS. 7 and 8.

While the illustrated elevator embodiment has an elevator platform 430 that is foldable between deployed and stowed configurations, this is not required. In other embodiments, the elevator platform is not foldable, but rather projects substantially perpendicular to the facing wall of the operator elevator at all times.

The operator elevator can optionally be equipped with a lock 760. In some cases, the lock 760 is configured to releasably lock the elevator platform 430 in the stowed configuration 755. As shown in FIG. 8, the lock 760 can comprise a lever (or “latch”) 766 and a bolt or rod 765. The lock 760 can have open and closed positions, and can be spring-biased toward the closed position.

The operator elevator 400 can optionally have a facing wall 715 located between two sidebars 720, 725 of the frame 710 such that two vertical gaps 730, 735 are formed between the two sidebars 720, 725 of the frame 710 and the facing wall 715. This is perhaps best shown in FIG. 7. In the illustrated embodiments, the elevator 10 has two brackets 740, 745 (or other portions of two shuttles) received respectively in the two vertical gaps 730, 735. The two brackets 740, 745 carry the wheels 700. The facing wall 715 preferably is a substantially vertical wall.

In the embodiment illustrated, the elevator 400 does not have any moving parts on a front side of the elevator above the brackets 740, 745. This is advantageous in that an operator riding the elevator 400 up or down the loader 10 does not encounter (e.g., come into contact with) moving parts at hand level on the front of the elevator 10. While this is not required in all embodiments of the invention, it is an advantageous safety feature in certain preferred embodiments. Thus, in any embodiment of the present disclosure, the operator elevator can optionally be devoid of moving parts on the front side of the elevator above: (i) the elevator platform 430, (ii) any brackets 740, 745 or other shuttle that carries the elevator platform 430 upwardly and downwardly, or above both (i) and (ii).

FIG. 13 depicts one non-limiting example of a hydraulic manifold block 625 that can be used with the present invention. The hydraulic system 600 can use conventional hydraulic components, which are commercially available from a variety of well-known sources, such as Parker Hannifin Corp. In the non-limiting example shown in FIG. 13, the system includes a power line 630 (optionally a 1 inch hose), which may be configured to deliver hydraulic fluid from a pump to the manifold block 625, a return power line 635 (optionally a 1¼ inch hose), which may be configured to deliver hydraulic fluid from the manifold block to a loader valve, cylinder hoses 688, which may be configured to deliver hydraulic fluid to and from A and B ports of the cylinder 800, flow restrictor valves 645 (e.g., flow restrictor needle valves), pilot source lines 617, a pressure test port 650, and a manual override handle 640. Various conventional valve banks (e.g., valve bank CVA 9521) may be used. Also shown in FIG. 13 are one or more wires to the pedals 466 and electric junction 467.

The hydraulic manifold block 625 preferably is on a power line 620 between the hydraulic pump 610 and the knuckle boom 100 (see also FIGS. 1 and 2). In such cases, the power line 620 comprises an ingress length 630 and an egress length 635. The ingress length 630 delivers hydraulic fluid from the hydraulic pump 610 into the hydraulic manifold block 625 of the operator elevator 400, whereas the egress length 635 delivers hydraulic fluid from the hydraulic manifold block 625 of the operator elevator 400 to the knuckle boom 100 (e.g., to a hydraulic valve and/or cylinder elsewhere on the loader, such as on the boom).

As shown in FIGS. 3-6, the operator elevator 400 can optionally be part of a single assembly that also includes pedestal 210, operator seat 220, and frame or other base 300. In such cases, the single assembly is structurally integral, e.g., it can be (when detached from the truck, trailer, platform, bases, or carriage on which it is mounted during operation) lifted or otherwise moved, such as by a suitable crane or the like, as a single unit. The hydraulic manifold 625 of the operator elevator 400 can optionally be part of this single assembly. In preferred embodiments, the frame or base 300 of the single assembly includes at least two outrigger (or “stabilizer”) legs 310. In addition, the frame or base 300 of the single assembly preferably includes a central support member (which can comprise a support column) 320, as described above. In the embodiment illustrated, the single assembly also includes an elevated deck 230, which has already been described.

In certain methods of the present invention, a loader 10 is used. In these methods, the loader can have an operator elevator 400 in accordance with any embodiment of the present disclosure. In some cases, an operator steps onto an elevator platform 430 and actuates a hydraulic cylinder 800 of the elevator 400. This actuation can optionally involve the operator stepping on a pedal 465 located on the elevator platform 430. As noted above, however, actuation can be accomplished in other ways. In response, hydraulic cylinder 800 moves axially and thereby forces the elevator platform 430 to move upwardly along the loader, thus moving the operator standing on the elevator platform upwardly from adjacent a ground surface 40 to adjacent an operator station 200 (and thus from a first elevation to a second, higher elevation). In such cases, it can be appreciated that the operator elevator 400 is configured to move between its lowered and raised positions in response to axial movement of a hydraulic cylinder 800.

In certain embodiments, the method involves the hydraulic cylinder 800 forcing a bushing 450 to move upwardly, thereby causing a sprocket 445 carried by the bushing to move along a chain 440 that is attached at one end to the elevator platform 430. This causes the first sprocket 445 to move along the first chain 440, such that the elevator platform 430 moves upward as the operator elevator 400 moves between its lowered 410 and raised 420 positions. The bushing 450 can optionally carry first and second sprockets 445, 460 that are respectively intermeshed with first and second chains 440, 455 of the nature described above. Thus, the method can optionally involve two sprockets 445, 460 moving respectively along two chains 440, 455, which are each attached at one end to the elevator platform 430.

In some cases, the present methods involve flowing hydraulic fluid (e.g., oil) through a hydraulic circuit and/or along a power line pathway on which are located both a hydraulic cylinder 800 of the elevator 400 and a hydraulic valve or cylinder elsewhere on the loader, such as on the boom 100. Thus, the present methods can optionally involve: (i) flowing a stream of hydraulic fluid through a power line and into a hydraulic manifold of the elevator, (ii) flowing some hydraulic fluid from that stream into a hydraulic cylinder of the operator elevator, and (iii) flowing some hydraulic fluid from that stream into a hydraulic valve and/or cylinder elsewhere on the loader, such as on the boom 100.

In some cases, hydraulic fluid flowing along a single hydraulic circuit and/or a single power line pathway flows first through a manifold and/or hydraulic lines of the operator elevator 400 and subsequently through a valve, cylinder, and/or hydraulic lines elsewhere on the loader, such as on the knuckle boom 100.

Thus, some embodiments of the invention provide a method for operating the knuckle boom loader 10. Preferably, the method involves an operator 50 stepping onto the operator elevator 400 and actuating the elevator (e.g., by depressing a first actuator pedal 465) to move the elevator to a raised position 420. The method can then involve the operator 50 stepping onto an elevated deck 230 and/or stepping onto an operator station 200, and thereafter sitting in an operator seat 220. The method may further include the operator 50 operating a control system of the knuckle boom loader 10 to move one or more items of material using the knuckle boom 100 and grapple 160. After the one or more items of material are moved, the method preferably includes the operator 50 stepping onto an elevated deck 230 and/or stepping onto the elevator platform 430. In some cases, the operator may be able to step direction from the operator station 200 onto the elevator platform 430. Preferably, the operator then actuates the elevator (e.g., depresses a second actuator pedal 470) to move the elevator to its lowered position 410.

In embodiments where the loader 10 has both the elevator 400 and a ladder 500, if desired, the operator can ride the elevator 400 up the loader and thereafter use the ladder 500 to get back down. Or, the operator could use the ladder 500 to get up to the operator station 200 and thereafter use the elevator 400 to get back down.

The illustrated operator elevator 400 does not include (i.e., is devoid of) an elevator cabin or other enclosure configured to surround the operator during use. Instead, it is an open-air elevator. Thus, the illustrated operator elevator 400 is devoid of any pedestrian doors. If desired, however, a cabin or other enclosure may be added. Furthermore, the present elevator preferably is not part of (e.g., is not mounted within) a building, such as a commercial or residential building. Thus, the present elevator preferably is not mounted for movement within an elevator shaft or configured to move between different floors of a building.

The operator elevator 400 preferably is not (and is not part of, and does not comprise) an operator cabin (e.g., on a vehicle or other machine) that is itself configured to move between different elevations, such as from a ground position to a raised position, which may be at an elevation more than three feet, six feet, or even eight feet higher than the ground position. For example, the frame 710 (e.g., sidebars 720, 725) of the elevator, and/or a facing wall 715 thereof, may be configured to remain in constant elevation (e.g., in fixed position) during upward and downward movement of the operator platform 430.

While some preferred embodiments of the invention have been described, it should be understood that various changes, adaptations and modifications may be made therein without departing from the spirit of the invention and the scope of the appended claims.

What is claimed is:

1. A knuckle boom loader having a knuckle boom, an operator seat, and a hydraulic system, the hydraulic system comprising a hydraulic fluid reservoir, a hydraulic pump, and hydraulic fluid lines, the knuckle boom loader further comprising an operator elevator, the operator elevator having an elevator platform, the operator elevator having a lowered position and a raised position, the elevator platform being closer to the operator seat when the operator elevator is in the raised position than when the operator elevator is in the lowered position.

2. The knuckle boom loader of claim 1 wherein, with the knuckle boom loader operably positioned, the elevator platform is: (i) adjacent a ground surface when the operator elevator is in the lowered position, and (ii) adjacent the operator seat when the operator elevator is in the raised position.

3. The knuckle boom loader of claim 1 wherein the hydraulic system comprises a single hydraulic power line pathway configured to power both the knuckle boom and the operator elevator.

4. The knuckle boom loader of claim 1 wherein the hydraulic fluid lines comprise a power line extending from the hydraulic pump to the knuckle boom, the operator elevator comprising a hydraulic manifold block, the hydraulic manifold block of the operator elevator being positioned on the power line between the hydraulic pump and the knuckle boom.

5. The knuckle boom loader of claim 4 wherein the power line comprises an ingress length that delivers hydraulic fluid from the hydraulic pump into the hydraulic manifold block of the operator elevator, and the power line comprise an egress length that delivers hydraulic fluid from the hydraulic manifold block of the operator elevator to the knuckle boom.

6. The knuckle boom loader of claim 1 wherein the knuckle boom loader includes two outrigger legs, the operator elevator being carried alongside a first of the two outrigger legs.

7. The knuckle boom loader of claim 6 wherein the knuckle boom loader includes a ladder carried alongside a second of the two outrigger legs.

8. The knuckle boom loader of claim 1 wherein the operator elevator comprises a first chain and a first sprocket, the elevator platform being operably connected to the first chain, the first sprocket being intermeshed with the first chain.

9. The knuckle boom loader of claim 8 wherein the operator elevator comprises a hydraulic cylinder operably coupled to a bushing on which the first sprocket is rotatably mounted, such that in response to axial movement of the hydraulic cylinder the bushing moves vertically, thereby causing the first sprocket to move along the first chain such that the elevator platform moves between raised and lowered positions.

10. The knuckle boom loader of claim 9 wherein the operator elevator comprises a second chain and a second sprocket, the elevator platform being operably connected to the second chain, the second sprocket being intermeshed with the second chain.

11. The knuckle boom loader of claim 10 wherein the second sprocket is rotatably mounted to the bushing, such that in response to axial movement of the hydraulic cylinder the bushing moves vertically, thereby actuating the first and second sprockets to move respectively along the first and second chains such that the elevator platform moves between raised and lowered positions.

12. The knuckle boom loader of claim 1 wherein the elevator platform has first and second actuator pedals.

13. The knuckle boom loader of claim 12 wherein, with the knuckle boom loader operably positioned, the elevator platform is configured to: (i) move upward in response to an operator stepping on the first actuator pedal, and (ii) move downward in response to the operator stepping on the second actuator pedal.

14. The knuckle boom loader of claim 1 wherein the operator elevator comprises wheels and tracks, the wheels being received in the tracks.

15. The knuckle boom loader of claim 14 wherein the operator elevator has a frame defining the tracks, and the wheels are mounted to the elevator platform.

16. The knuckle boom loader of claim 15 wherein the operator elevator has a facing wall located between two sidebars of the frame such that two vertical gaps are formed between the two sidebars of the frame and the facing wall.

17. The knuckle boom loader of claim 16 wherein the elevator platform has two brackets received respectively in the two vertical gaps, the two brackets carrying the wheels.

18. The knuckle boom loader of claim 1 wherein the elevator platform has a deployed configuration and a stowed configuration, the elevator platform being pivotable between the deployed configuration and the stowed configuration.

19. The knuckle boom loader of claim 18 wherein the operator elevator has a lock configured to releasably lock the elevator platform in the stowed configuration.

20. The knuckle boom loader of claim 1 wherein the operator elevator further comprises a handle.
